(19) United States
(12) Patent Application Publication
(10) Pub. No.: US 2014/0334082 A1
(43) Pub. Date: Nov. 13, 2014

(54) DISPLAY DEVICE

(71) Applicant: TPV-INVENTA Technology Co., Ltd., Taipei (TW)

(72) Inventors: Jiun-Hong Wang, Taipei (TW); Po-Lin Lin, Taipei (TW); Chin-Chang Liu, Taipei (TW)

(21) Appl. No.: 13/934,490

(22) Filed: Jul. 3, 2013

(30) Foreign Application Priority Data
May 10, 2013 (TW) 102208771

(51) Int. Cl. G06F 1/16; F16M 11/18

(52) U.S. Cl. CPC G06F 1/1637; F16M 11/18
USPC 361/679.3

(57) ABSTRACT

The disclosure provides a display device, comprising a connecting component, a base, a display monitor and a sliding unit. The connecting component includes a first end and a second end opposite to each other. The first end of the connecting component is pivoted on the base. The sliding unit is disposed on the display monitor. The second end of the connecting component is slidably pivoted on the sliding unit.

### CROSS-REFERENCE TO RELATED APPLICATIONS

This non-provisional application claims priority under 35 U.S.C. §119(a) on Patent Application No(s). 102208771 filed in Taiwan, R.O.C. on May 10, 2013, the entire contents of which are hereby incorporated by reference.

### BACKGROUND OF THE INVENTION

1. Technical Field of the Invention

The disclosure relates to a display device, and more particularly to a display device including a connecting component, a base, a display monitor and a sliding unit.

2. Description of the Related Art

With the development of technology, operating electronic products by all kinds of touching control manners is widely used by users. Therefore, not only mobile phones, tablet computers, but also display monitors including touching interfaces are becoming popular products in the market.

Take a touch screen for example, a user holds his/her hand in the air to hold the touch screen and then operates the touch screen by touching it directly, which makes the users arm feel tired or sore when the user operates it for a long time. As for the tablet computer, the angle of the screen of the tablet computer is fixed, so the user needs to coordinate the position of the tablet computer, which also makes the user feel tired or sore when the user operates it for a long time. Therefore, how to design a display device to solve the above-mentioned problems that the user needs to coordinate the viewing height and viewing angle of the display device, which makes the user feel tired when the user operates it for a long time, is what technicians are trying to fix.

### SUMMARY OF THE INVENTION

An embodiment of the disclosure provides a display device, comprising a connecting component, a base, a display monitor and a sliding unit. The connecting component includes a first end and a second end opposite to each other. The first end of the connecting component is pivoted on the base. The sliding unit is disposed on the display monitor. The second end of the connecting component is slidably pivoted on the sliding unit.

### BRIEF DESCRIPTION OF THE DRAWINGS

The disclosure will become more fully understood from the detailed description given herein below for illustration only, thus does not limit the disclosure, wherein:

FIG. 1A is a schematic perspective view of a display device according to an embodiment of the disclosure;

FIG. 1B is a schematic exploded view of the display device in FIG. 1A;

FIG. 1C is a schematic back side view of the display device in FIG. 1A; and

FIGS. 2A to 2E are schematic side views of the display device in different operating modes.

### DETAILED DESCRIPTION

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

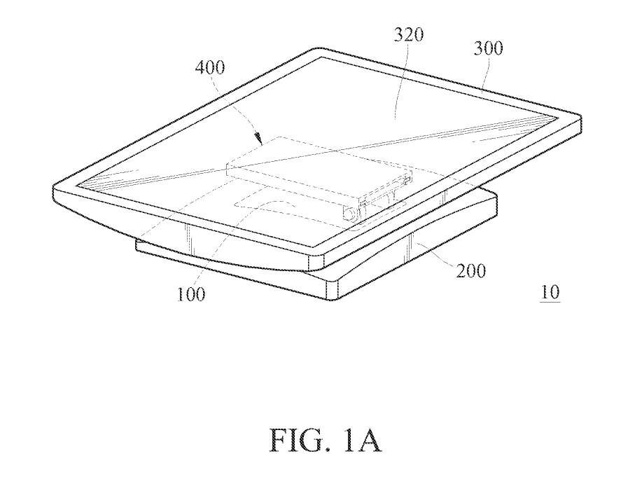

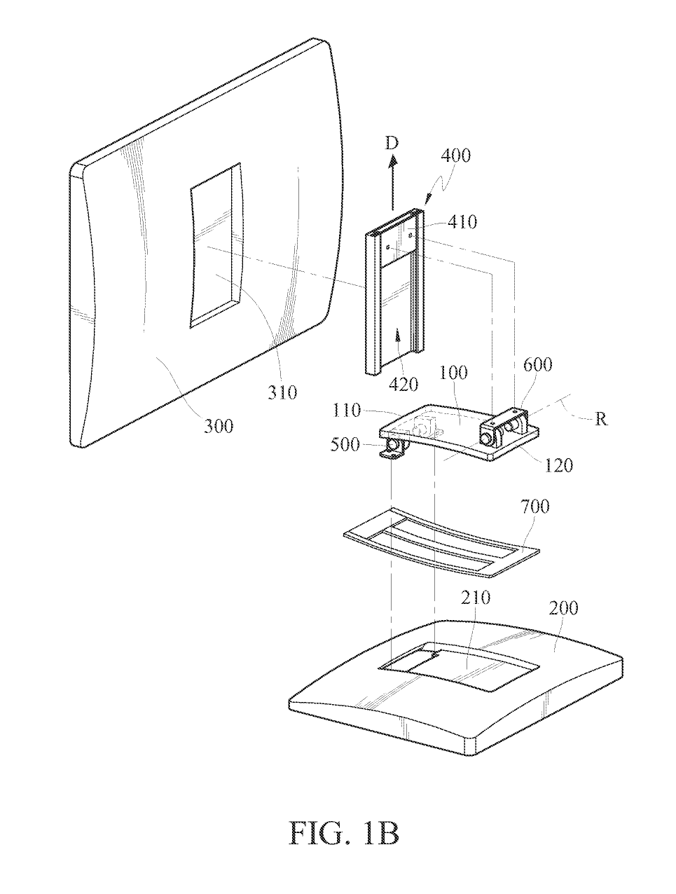

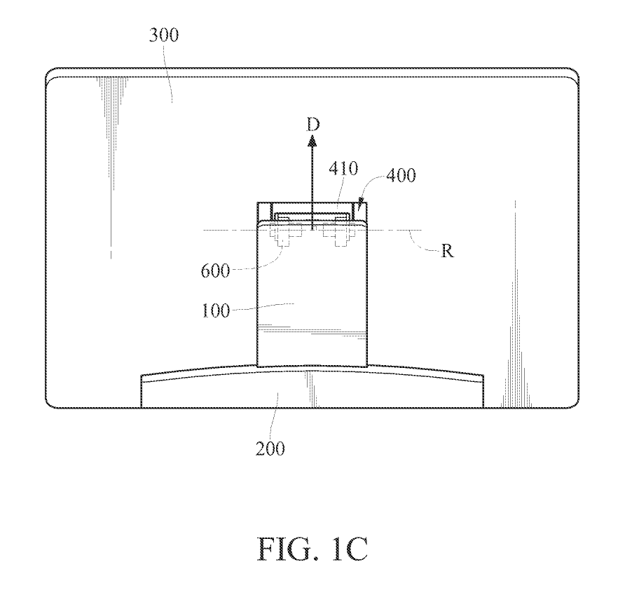

Please refer to FIGS. 1A to 1C. FIG. 1A is a schematic perspective view of a display device according to an embodiment of the disclosure. FIG. 1B is a schematic exploded view of the display device in FIG. 1A. FIG. 1C is a schematic back side view of the display device in FIG. 1A.

A display device 10 comprises a connecting component 100, a base 200, a display monitor 300 and a sliding unit 400. In this and some other embodiments, the display device 10 further comprises a first pivoting component 500 and a second pivoting component 600.

The connecting component 100 includes a first end 110 and a second end 120 opposite to each other. The base 200 includes an accommodation notch 210, and the size of the accommodation notch 210 matches that of the connecting component 100. The first end 110 of the connecting component 100 is pivoted on the accommodation notch 210 of the base 200. Furthermore, the first pivoting component 500 is securely disposed on the first end 110 of the connecting component 100, and the base 200 is pivoted on the first end 110 of the connecting component 100 via the first pivoting component 500. Therefore, the connecting component 100 is adapted for pivoting with respect to the base 200 so as to include a closing position and an opening position.

The display monitor 300 includes a display area 320 and a connecting area 310 located oppositely from the display area 320. In other words, the display area 320 and the connecting area 310 are located on two opposite sides of the display monitor 300, respectively. The sliding unit 400 is disposed on the connecting area 310 of the display monitor 300, and the second end 120 of the connecting component 100 is pivoted on the sliding unit 400. In this embodiment, the sliding unit 400 comprises a sliding track 420 and a sliding component 410. The sliding component 410 is slidably (namely, slidably means being slid into and being moved) disposed on the sliding track 420, and the second end 120 of the connecting component 100 is pivoted on the sliding component 410. Therefore, the sliding component 410 of the sliding unit 400 is adapted for sliding and moving in the sliding track 420 such that the connecting component 100 is adapted for moving linearly with respect to the display monitor 300.

Moreover, the second pivoting component 600 is securely disposed on the second end 120 of the connecting component 100, and the sliding unit 400 is pivoted on the second end 120 of the connecting component 100 via the second pivoting component 600.

It should be noted that the display device 10 comprising the first pivoting component 500 and the second pivoting component 600 is not limited to the disclosure. In other embodiments of the disclosure, the first end 110 of the connecting component 100 is directly pivoted on the accommodation notch 210 of the base 200, and the second end 120 of the connecting component 100 is directly pivoted on the sliding unit 400.

Furthermore, the sliding component 410 in this embodiment is slid into and moved inside the sliding track 420 along a guiding direction D, and the second end 120 of the connecting component 100 is adapted for pivoting with respect to the sliding unit 400 along an axial direction R. In this embodiment, the guiding direction D is substantially perpendicular to the axial direction R (as shown in FIG. 1C). That is to say, when the sliding component 410 of the sliding unit 400 is slid and moved along the sliding track 420 of the sliding unit 400, the relative position between the display monitor 300 and the base 200 is maintained the same along the left-right direction in FIG. 1C.

Accordingly, the sliding unit 400 is disposed on the display monitor 300, the second end 120 of the connecting component 100 is pivoted on the sliding component 410 of the sliding unit 400, and the two ends 110, 120 of the connecting component 100 are pivoted on the base 200 and the sliding unit 400, respectively, such that a user is adapted for taking the first pivoting component 500 or the second pivoting component 600 as a rotating axis to rotate the display monitor 300 with respect to the base 200 or sliding the display monitor 300 along the sliding track 420.

In order to protect the connecting component 100 and to improve the appearance of the display device 10, in this and some other embodiments, the display device 10 further comprises a protecting cover 700, and the protecting cover 700 is disposed on a side of the connecting component 100 facing the base 200. Therefore, the disposing of the protecting cover 700 strengthens the structure of the connecting component 100 and improves the visual beauty of the display device 10. It should be noted that the display device 10 which comprises the protecting cover 700 is not limited to the disclosure.

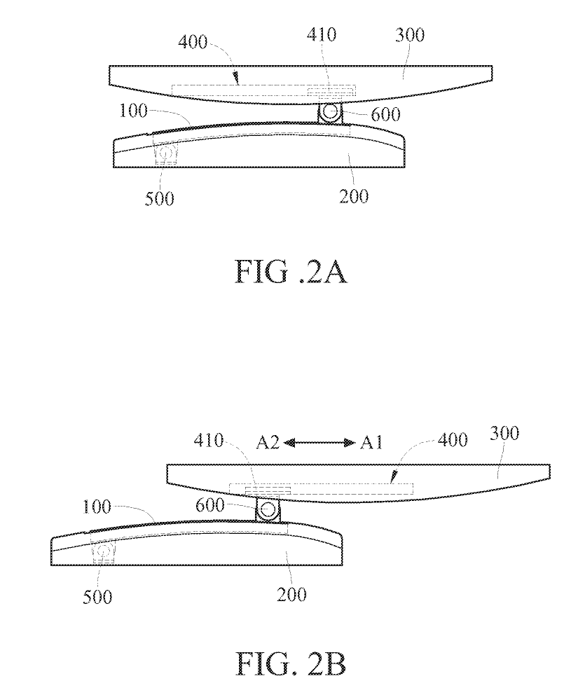

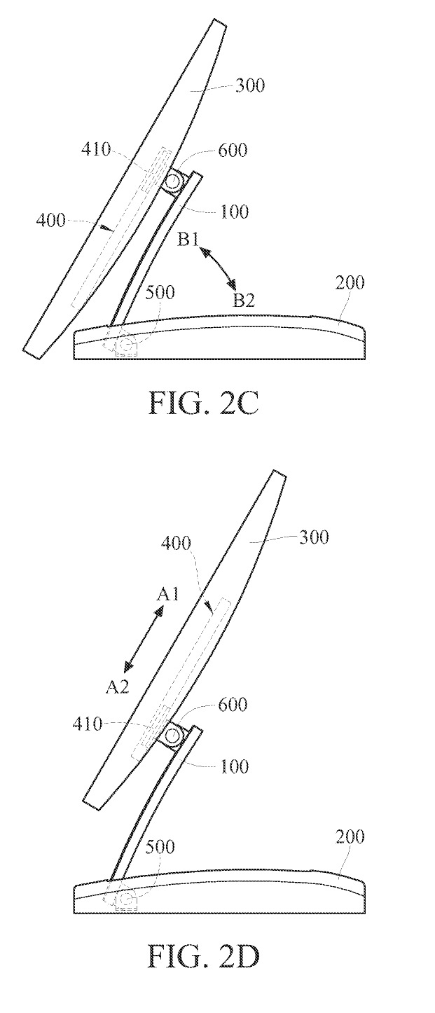

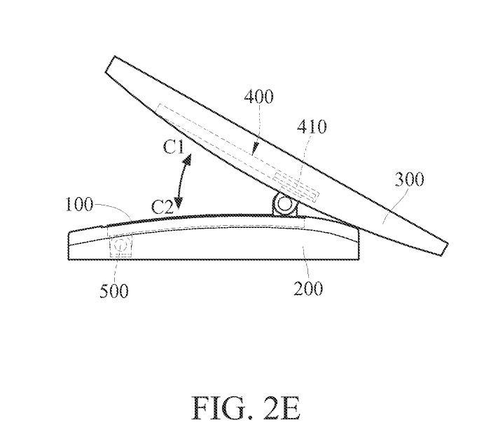

The following describes different operating modes of the display device. Please refer to FIGS. 2A to 2E, which are schematic side views of the display device in different operating modes.

First, when the connecting component 100 is pivoted with respect to the base 200 to be located at the closing position, the angle, formed between the display monitor 300 and the base 200, is 0 degrees, and the connecting component 100 is contained in the accommodation notch 210 (as shown in FIGS. 2A and 2B). At this time, a user is adapted for moving the display monitor 300 along the sliding track 420, so the display monitor 300 is slid and moved along a direction A1 or another direction A2 so as to adjust the relative position between the display monitor 300 and the base 200.

When the user needs to stand the display monitor 300 to operate, the user is adapted for taking the first pivoting component 500 as a rotating axis to rotate the display monitor 300, such that the display monitor 300 rotates along a direction B1 or another direction B2 to adjust the angle formed between the display monitor 300 and the base 200 (as shown in FIG. 2). Therefore, the viewing angle is adjusted according to the operation of the user.

In this embodiment, when the display monitor 300 rotates along the direction B1 or the direction B2, the angle, formed between the display monitor 300 and the base 200, is an acute angle. Furthermore, the acute angle is between 0 degrees to 60 degrees. However, the opened angle between the display monitor 300 and the base 200 is not limited to the disclosure.

After the user rotates the display monitor 300 with respect to the base 200, the user is adapted for moving the display monitor 300 along the sliding track 420, such that the display monitor 300 is slid along the direction A1 or the direction A2 to adjust the relative position between the display monitor 300 and the base 200 (as shown in FIG. 2D), thereby matching the viewing height of the operation of the user.

On the other hand, when the user does not need to stand the display monitor 300 to operate, the user may selectively take the second pivoting component 600 as a rotational axis to rotate the display monitor 300, such that the display monitor 300 rotates along a direction C1 or another direction C2 so as to adjust the angle formed between the display monitor 300 and the base 200 (as shown in FIG. 2E). Therefore, the user may rotate the display monitor 300 in different directions so as to provide another operating mode for the user or to allow another user to operate the display device 10.

In this embodiment, when the display monitor 300 rotates along the direction C1 or the direction C2, the angle, formed between the display monitor 300 and the base 200, is between 0 to 28 degrees. However, the opening angle between the display monitor 300 and the base 200 is not limited to the disclosure.

According to the display device provided by the above-mentioned embodiments of the disclosure, the display monitor is pivoted, slid and moved with respect to the base to include different operating modes, so it is convenient for the user to operate. Because the display monitor is pivoted with respect to the base so as to be lain on the base, the user does not need to hold his/her hand in the air to operate the display device, such that it is easy for the user to operate. On the other hand, the display monitor is also pivoted and slid with respect to the base, such that the user rotates or slides the display monitor to match the viewing height and viewing angle of the user. In other words, the user does not need to coordinate with the display monitor to operate, so it is comfortable for the user to operate. Therefore, the display device in this disclosure solves the problem that the user needs to coordinate the viewing height and viewing angle of the display device, which makes the user not be able to operate the display device in a long time.

What is claimed is:

1. A display device, comprising:
a connecting component including a first end and a second end opposite to each other;
a base, the first end of the connecting component being pivoted on the base;
a display monitor; and
a sliding unit disposed on the display monitor, wherein the second end of the connecting component is slidably pivoted on the sliding unit.

2. The display device according to claim 1, wherein the sliding unit comprises a sliding track and a sliding component, wherein the sliding component is slidably disposed on the sliding track, and the second end of the connecting component is disposed on the sliding component.

3. The display device according to claim 2, wherein the sliding component is adapted for sliding into the sliding track along a guiding direction, the second end of the connecting component is adapted for pivoting with respect to the sliding unit along an axial direction, and the guiding direction is substantially perpendicular to the axial direction.

4. The display device according to claim 1, further comprising a first pivoting component securely disposed on the first end of the connecting component, wherein the base is pivoted on the first end of the connecting component via the first pivoting component.

5. The display device according to claim 1, further comprising a second pivoting component securely disposed on the second end of the connecting component, and the sliding unit is pivoted on the second end of the connecting component via the second pivoting component.

6. The display device according to claim 1, further comprising a protecting cover disposed on a side of the connecting component facing the base.

7. The display device according to claim 1, wherein the base includes an accommodation notch, wherein the size of the accommodation notch matches that of the connecting component, the first end of the connecting component is pivoted on the accommodation notch of the base, the connecting component is pivoted with respect to the base to include a closing position and an opening position, and wherein at the closing position, the connecting component is stored in the accommodation notch, and at the opening position, the connecting component and the base form an acute angle therebetween.

8. The display device according to claim 1, wherein the display monitor includes a display area, wherein the sliding unit is a disposed on a side of the display monitor facing oppositely from the display area.
